(19) United States
(12) Patent Application Publication
(10) Pub. No.: US 2019/0156614 A1
(43) Pub. Date: May 23, 2019

(54) VENDING MACHINE SYSTEM AND METHOD OF USE

(71) Applicant: Bryann Ross, Arlington, TX (US)

(72) Inventor: Bryann Ross, Arlington, TX (US)

(21) Appl. No.: 16/194,359

(22) Filed: Nov. 18, 2018

Related U.S. Application Data
(60) Provisional application No. 62/588,340, filed on Nov. 18, 2017.

(51) Int. Cl. G07F 11/42; G07F 11/58; G07F 7/00; G07F 9/10

(52) U.S. Cl. CPC G07F 11/42; G07F 11/58; G07F 7/04; G07F 9/10; G07F 7/005

(57) ABSTRACT

A vending machine system includes a body having a front panel and a back panel; an interactive display incorporated into the front panel to receive commands from a user; a payment system to receive a payment from the user; a delivery chute extending through the front panel and into an interior of the body; conveyer systems secured within the interior of the body, each of the conveyer systems having one or more brackets; a conveyer belt held via the one or more brackets; a control system to communicate with the interactive display; a motor engaged with the control system and to facilitate movement of the conveyer belt; the conveyer systems deliver products to the delivery chute based on commands received through the interactive display.

### BACKGROUND

### 1. Field of the Invention

The present invention relates generally to a vending machine system and methods of use. More specifically, the invention is related to a system and method to dispense products through portable and customizable vending machine apparatus.

### 2. Description of Related Art

Vending machine systems are well known in the art and are effective means to sell products and collect payment. For example, FIG. 1 depicts a conventional vending machine system 101 having a body 103 with a door 117 and having a plurality of chambers 119 with spiral retainers 105 connected to a motor (not shown). During use, a user selects an item through a screen 115 and makes a payment through a cash receiver 107, coin receiver 109, and one or more buttons 121, wherein change is delivered through a money return 111 and the product is dropped via chamber 119 into dispenser 113. It should be appreciated that the payment and selection activates the motor to rotate the spiral 105 to deliver the product via dispenser 113.

One of the problems commonly associated with system 101 is the standard size of body 103. For example, many smaller locations may not have room for a standard sized vending machine system 101.

Although great strides have been made in the area of packing systems and methods of use, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an oblique view of a common vending machine system;

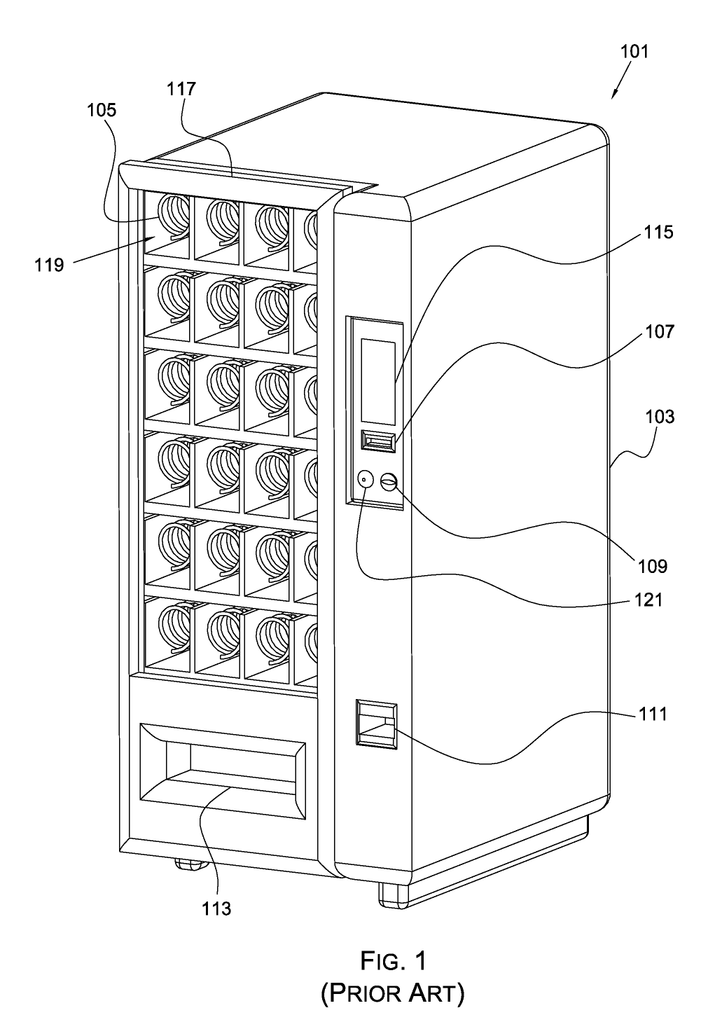

FIG. 2 is an oblique view of a vending machine system in accordance with a preferred embodiment of the present application;

FIG. 3 is an oblique view of the vending machine system of FIG. 2 with a front removed;

FIG. 4 is an oblique view of a conveyer system of FIG. 2;

FIG. 5 is an oblique view of a vending machine system in accordance with an alternative embodiment of the present application; and

FIG. 6 is an oblique view of an alternative embodiment of a conveyer system in accordance with the present application.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional systems and methods to automatically distribute products. Specifically, the present invention is directed to a slim and portable vending machine that includes automated payment and distribution of the products. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

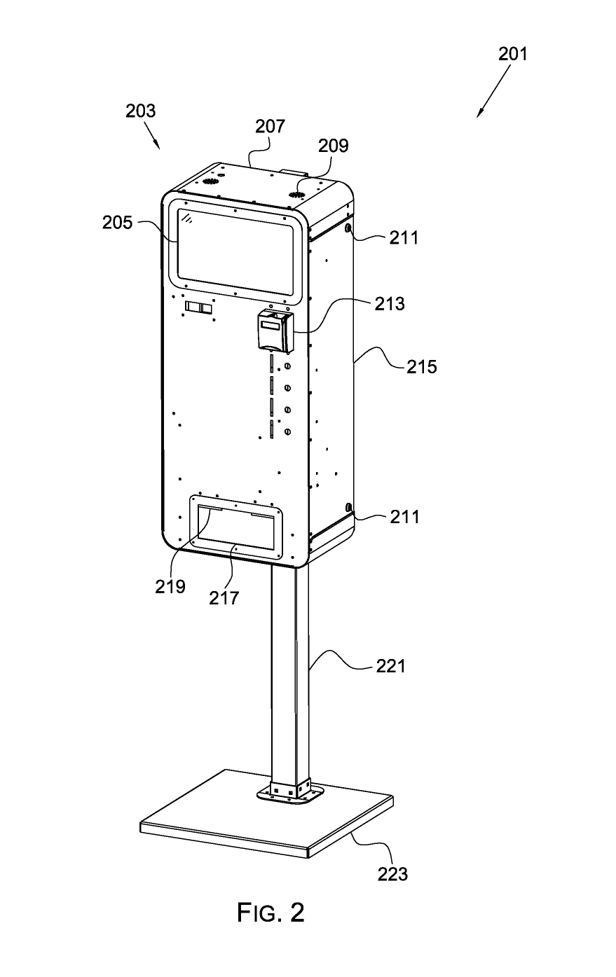

Referring now to the drawings wherein like reference characters identify corresponding or similar elements throughout the several views, FIGS. 2-4 depict various views of a system 201 and method of use in accordance with a preferred embodiment of the present application. It will be appreciated that system 201 overcomes one or more of the above-listed problems commonly associated with the conventional systems and methods to automatically sell and distribute products.

Referring to FIG. 2, an oblique view of the system 201 for an automated and portable vending machine is shown having a body 203 with a front panel mounted to a back panel 215 via one or more bolts/screws 211. The front panel houses a visual display 205 configured to be manipulated by the user to make a selection from the items within the vending machine, a payment interface 213 which can include various components, such as a credit card receiver, cash receiver, and coin receiver is further included to facilitate the transaction. It should further be appreciated that cashless payments can be used. In some embodiments, one or more speakers 209 are included for audio alerts and notifications. It should be appreciated and understood that the display can be configured to wirelessly communicate with one or more devices.

Upon purchasing an item, via display 205 and payment interface 213, the item is dropped through the body and to a chute, wherein a retrieving door 217 is secured via hinge 219.

In the preferred embodiment, the body 203 is mounted on a stand 221 and base 223. This piece is attached to a structural back plate 215 in such a way that it is allowed to swing on a hinge and maintain its form and durability.

The present invention ensures that all the pieces are easily installed and removed. Additionally, all cabling and wiring is hidden from view and safe from damage. This is accomplished by configuring the mounting plates and covers to be installed and removed easily. The cabling is protected by ensuring that it is double sheathed and fits inside the protective covers.

It is anticipated that double locks are used to help secure the inside of the machine from left. The locks are opposing so that once the machine is locked, no one can lift it and cause the door to open.

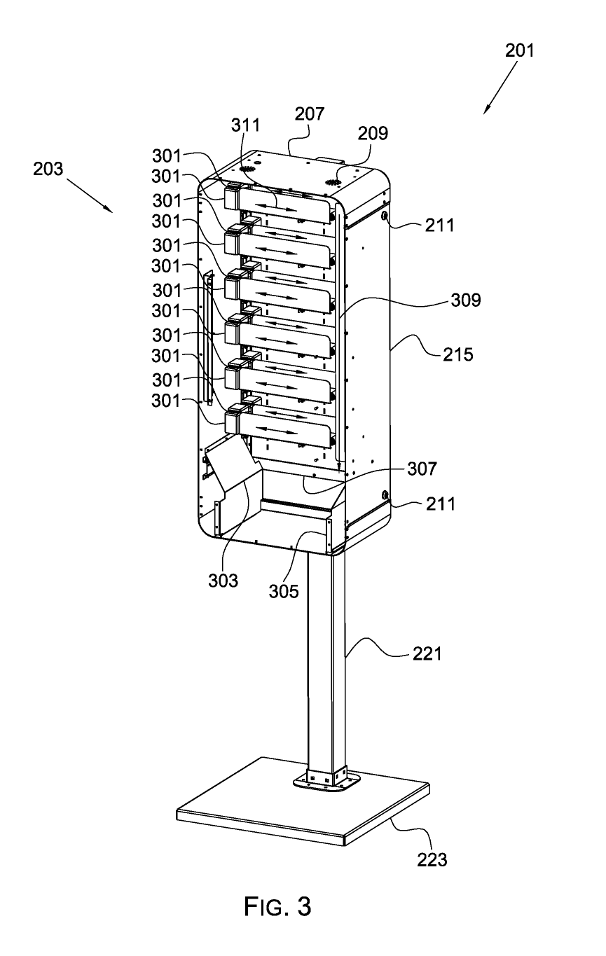

Referring now to FIG. 3, an oblique view of system 201 is shown, wherein a front panel is removed. As shown, the body 203 houses a plurality of conveyer systems 301, wherein each of the conveyer systems is configured to hold products and include conveyer belts to traverse 311 the products. Each conveyer system is in communication with the display and configured to receive commands, wherein a command signals the conveyer system to drop a product into the receiving chute. The receiving chute can include drop sensors 307 configured to ensure that products are provided to the consumer. In addition, the receiving chute can include a first side 303 and a second side 305 to protect and facilitate delivery of the products. The conveyer systems deliver the product to a vertical chute 309, wherein the product is then transferred to the receiving chute.

It should be appreciated that the visual aesthetics and size of the vending machine system 201 can vary based on various embodiments.

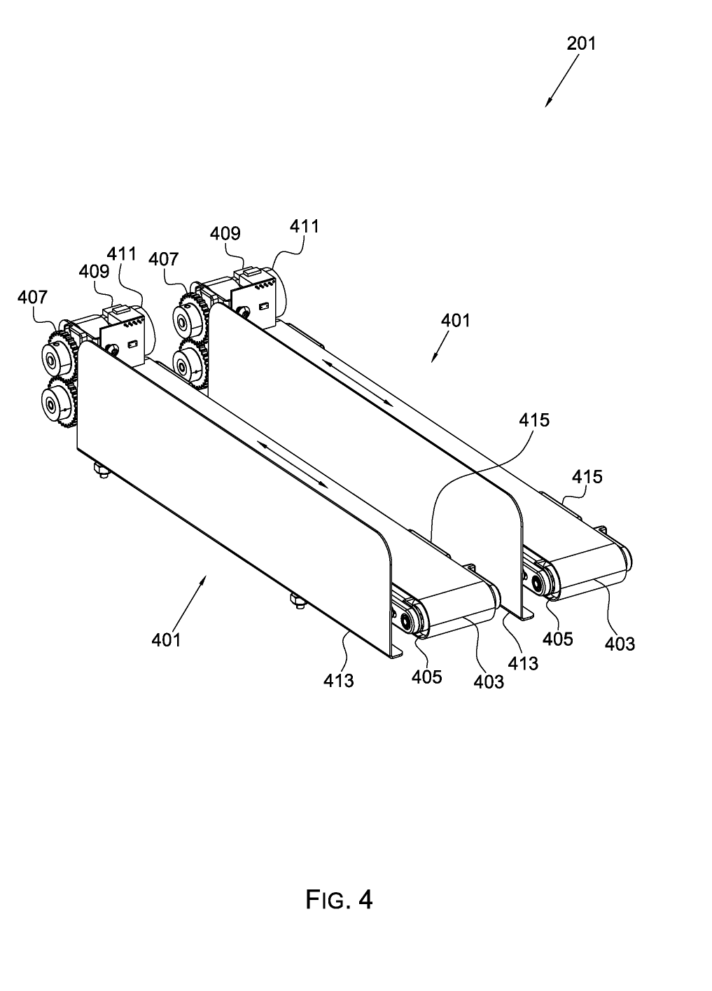

As shown in FIG. 4, one contemplated conveyer system 401 includes conveyer belts 403 configured to hold and transfer products. The belts are held in place via one or more brackets 413, 415 and bearings 405. During use, a motor 411 associated with the appropriate conveyer system is activated, wherein gears 407 are turned to further activate the conveyer belt. Each conveyer can have a control system 409 to receive commands from the display.

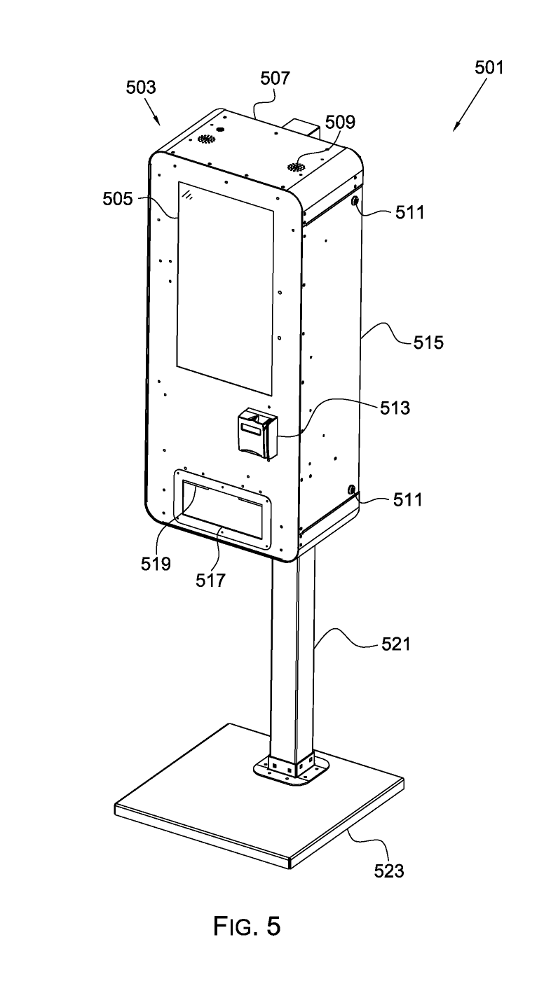

In FIG. 5, an oblique view of an alternative embodiment of a vending machine system 501 for an automated and portable vending machine is shown having a body 503 with a front panel mounted to a back panel 515 via one or more bolts/screws 511. The front panel houses a visual display 505, which in this embodiment is approximately 24 inches long and configured to be manipulated by the user to make a selection from the items within the vending machine, a payment interface 513 which can include various components, such as a credit card receiver, cash receiver, and coin receiver is further included to facilitate the transaction. In some embodiments, one or more speakers 509 are included for audio alerts and notifications. It should be appreciated and understood that the display can be configured to wirelessly communicate with one or more devices.

Upon purchasing an item, via display 505 and payment interface 513, the item is dropped through the body and to a chute, wherein a retrieving door 517 is secured via hinge 519. The body 503 is mounted on a stand 521 and base 523.

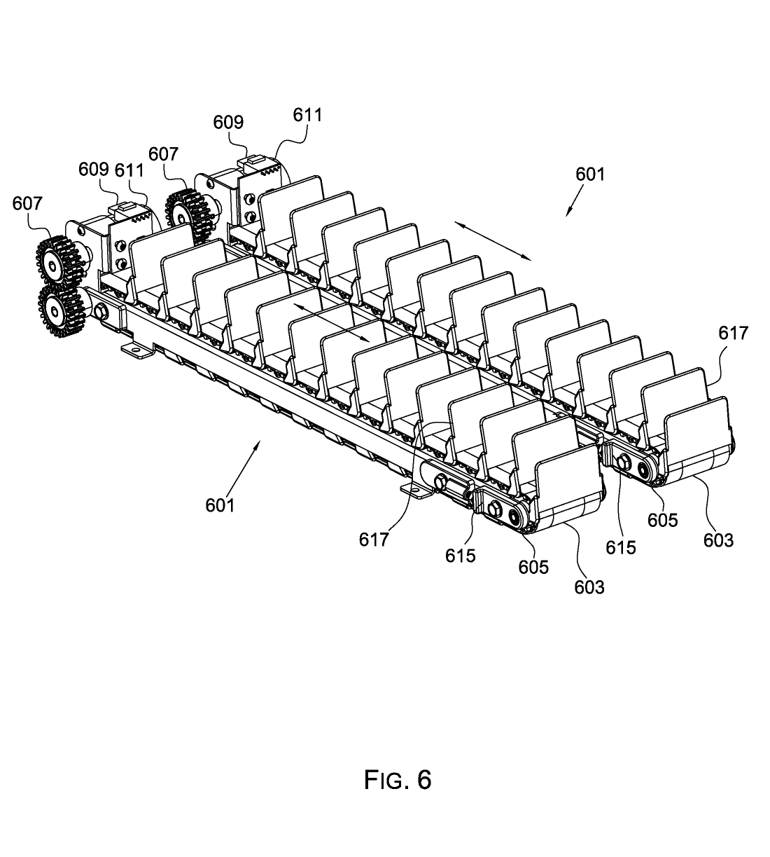

In FIG. 6, an oblique view of an alternative embodiment of a conveyer system 601 is shown. Conveyer system 601 includes all of the features discussed above in connection with system 401, including belts 603 configured to hold and transfer products. The belts are held in place via one or more brackets 613, 615 and bearings 605. During use, a motor 611 associated with the appropriate conveyer system is activated, wherein gears 607 are turned to further activate the conveyer belt. Each conveyer can have a control system 609 to receive commands from the display. Further, conveyer system 601 includes a plurality of paddles 617 for separation of the products.

It should be appreciated that the system is only limited by the available space inside the machine. As an exemplary embodiment, the system can have three conveyers wide with 10 conveyers tall, making a total of 30 conveyers. The system can be expanded to increase the capacity therein. The electronic components involved can be expanded to manage larger capacities as desired.

The system of the present invention is fully interactive, connected via cellular, Wi-Fi or hardline to remote servers and can be remotely managed though proprietary software technology. Operators are able to remotely manage inventory levels in their machines, set pricing, upload advertisements, check and clear most faults, manage sales, promotions and special offers, all in real time. Companies today are faced with many challenges but the biggest by far is their inability to expand distribution without the huge cost of setting up brick and mortar locations. Once they have invested hundreds of thousands of dollars into stores they are then stuck in a lease for a period of time no matter what happens to the economy. The Slimline product is not only a flexible system it is light weight, versatile and cosmetically appealing fitting into any space in any location from airports to strip malls. With an overall weigh of less than 100 Lbs. it is much easier to move from place to place than conventional vending machines. Being able to showcase products in multiple locations and advertise those and other products on the screen as well as monitor sales in real time adds significant value to this unit. Further value comes for the fact that this machine can be mounted directly to the wall or attached to a custom designed stand so as to not cause any damage to the location. The machine is powered by a 110 volt ac to a 12 volt dc supply thereby giving a much greater level of protection to users from shock. Machines can be fitted with cameras so that facial recognition can be accomplished as well as social media interaction. The ability to change the graphics on the machine at a very low cost further shows the true value of these machines. A machine and its stand fit perfectly into a single box of a size 42″×20″×20″ and the total overall weight is approx. 125 lbs. This makes it easy to store and transport adding yet another value to the system.

A summary of key features include: 1. 15.6″ ad screen or 24″ touch screen or 27″ touch screen 2. Adjustable sleeves for the drop system with a minimum of 2.5″ wide to 22″ wide 3. Adjustable trays for the horizontal delivery with tray width of a maximum of 9″ facilitating up to three individual delivery conveyors. 4. Adjustable product holder that facilitates a product of ½″ tall to 4″ tall 5. Motor pusher affixed to the bottom under each vertical chute also fully adjustable from left to right 6. Motor affixed to the back of each conveyor for the horizontal delivery 7. Drop sensors in the delivery bin to detect successful or failed vends 8. Remote management of all inventory and digital advertising. 9. Machine can have button press delivery or touch screen delivery. 10. 12 volt DC system.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A vending machine system, comprising:
a body having a front panel and a back panel;
an interactive display incorporated into the front panel and configured to receive commands from a user;
a payment system configured to receive a payment from the user;
a delivery chute extending through the front panel and into an interior of the body;
a plurality of conveyer systems secured within the interior of the body, each of the plurality of conveyer systems having:
one or more brackets;
a conveyer belt held via the one or more brackets;
a control system configured to communicate with the interactive display;
a motor engaged with the control system and configured to facilitate movement of the conveyer belt;
wherein the plurality of conveyer systems deliver products to the delivery chute based on commands received through the interactive display.

2. The system of claim 1, further comprising:
a vertical chute extending within the interior of the body and positioned to receive products from the plurality of conveyer systems to deliver products to the delivery chute.

3. The system of claim 2, wherein the plurality of conveyer systems are positioned perpendicular to the vertical chute.

4. The system of claim 1, further comprising:
an elongated stand; and
a base;
wherein the elongated stand extends between the base and the body.
